(19) United States
(12) Patent Application Publication
(10) Pub. No.: US 2008/0074652 A1
(43) Pub. Date: Mar. 27, 2008

(54) Retroreflector-based system and method for detecting intrusion into a restricted area

(76) Inventors: Julie E. Fouquet, Portola Valley, CA (US); Richard Haven, Sunnyvale, CA (US); Shalini Venkatesh, Santa Clara, CA (US); Akihiro Machida, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/521,750

(22) Filed: Sep. 15, 2006

(51) Int. Cl. G01C 21/02; G01J 1/20

(52) U.S. Cl. 356/218; 250/203.1

(57) ABSTRACT

Embodiments of the present invention include a system for detecting entry of an object from a first area into a second area. The system includes a light source for generating a light beam, the light beam defining a boundary between the first area and the second area. The system further includes a retroreflector positioned across from the light source, the retroreflector for reflecting the light beam back towards the light source and a photodetector positioned adjacent to the light source, the photodetector for detecting the reflected light beam wherein the photodetector generates a signal in response to detecting an interruption in the light beam signaling entry of an object from the first area to the second area.

### TECHNICAL FIELD

The present invention relates to optical sensors. More specifically, embodiments of the present invention relate to optical sensors used for detecting intrusion into a restricted area.

### BACKGROUND ART

In airports, security personnel must be stationed at exits from restricted areas to make sure unauthorized persons are not allowed into these areas without a proper security check. A group with ill intentions may be able to distract a security guard and send someone past the guard and into the restricted area via the exit. Posting multiple guards may decrease the chances of entering past a single distracted guard, but salary costs may prohibit this arrangement.

Some points of entry cannot be easily guarded by conventional burglar alarm technology. Jalousie or casement windows (e.g., crank open) are not easy to install alarm systems on. Furthermore, conventional magnetic sensors used with the more common sliding window typically only accommodate two positions (e.g., open and closed). Depending on the weather, a person may want to open the window to a different width e.g., fully open and still retain some security features. Attempting to accommodate a third position (e.g., a partially open window) with the conventional magnetic burglar alarm device could lead to a system malfunction.

One conventional security system is based on interrupting optical light beams. This system uses a light source on one side and a photodetector on the opposite side. When the light beam is broken, the alarm is activated. One problem with this system is that careful alignment of the photodetector is required to avoid false alarms. In this type of system, if the photodetector or light source is positioned incorrectly, the system will not operate correctly. Furthermore, this type of system is prone to malfunctions caused by light artifacts such as light reflected from a piece of jewelry.

A more flexible system for detecting intrusion into a restricted area would be an improvement over the art.

### SUMMARY OF THE INVENTION

Embodiments of the present invention include a system for detecting entry of an object from a first area into a second area. The system includes a light source for generating a light beam, the light beam defining a boundary between the first area and the second area. The system further includes a retroreflector positioned across from the light source, the retroreflector for reflecting the light beam back towards the light source and a photodetector positioned adjacent to the light source, the photodetector for detecting the reflected light beam wherein the photodetector output is normally high but then falls in response to detecting an interruption in the light beam signaling entry of an object from the first area to the second area.

Embodiments of the invention also include a system for detecting entry of an object from a first area to a second area comprising a linear array of individual light sources for generating a plurality of light beams, the light beams forming a light plane separating a first area from a second area. The system further includes one or more retroreflectors positioned across from the linear array of individual light sources, the retroreflector for reflecting the plurality of light beams back to the individual light sources. The system further includes a plurality of photodetectors positioned adjacent to the light sources, the photodetectors for detecting the reflected light beams and a processor coupled to the plurality of photodetector for generating a signal in response to one of the plurality of photodetector detecting an interruption in one of the plurality of light beams.

Additional embodiments of the present invention include generating a plurality of light beams at a plurality of light sources, the light beams forming a box of light (e.g., a light plane) separating a first area from a second area, reflecting the plurality of light beams back to the individual light sources by one or more retroreflectors positioned across from the linear array of individual light sources, detecting the reflected light beams at a plurality of photodetectors positioned adjacent to the light sources, detecting an interruption in one of the plurality of light beams, and generating an alarm signal in response to the interruption.

In one embodiment of the invention, comparing the time of light interruption for photodetectors arranged in an array along the direction of restricted movement can allow the direction of travel (e.g., right direction vs. wrong direction) to be determined electronically. If a person is detected traveling in the wrong direction, an alarm can be sounded.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of an exemplary system for detecting entry of an object from a first area to a second area in accordance with embodiments of the present invention.

FIG. 2 is an illustration of an exemplary entry detection system implemented to protect a point of entry using a plane of light in accordance with embodiments of the present invention.

FIG. 3 is a block diagram of an exemplary method of detecting entry of an object from a first area to a second area in accordance with embodiments of the present invention.

FIG. 4A is an illustration of a corridor illuminated by an exemplary two-dimensional array of optoelectronic units for detecting a direction of entry in accordance with embodiments of the present invention.

FIG. 4B is an illustration of a corridor illuminated by an exemplary two-dimensional array of optoelectronic units across from a wall of retroreflective material for detecting a direction of entry in accordance with embodiments of the present invention.

FIG. 4C is an illustration of a corridor illuminated by two exemplary linear arrays of optoelectronic units creating two sheets of light for detecting a direction of entry in accordance with embodiments of the present invention.

FIG. 5 is a block diagram of an exemplary computer system in accordance with embodiments of the present invention.

### DETAILED DESCRIPTION OF THE INVENTION

Embodiments of the present invention provide a system and method for electronic access control. In one embodiment of the invention, the direction of travel of a person or object through a corridor can be determined. In another embodiment of the invention, if an object or person enters into a restricted area, an alarm signal is generated. Therefore, if a guard in an airport for example is distracted, embodiments of the present invention can sound an alarm to enforce security.

Embodiments of the present invention generate a sheet (e.g., a two dimensional plane) or box (e.g., a three dimensional volume) of light that protects a point of entry or a corridor form unauthorized entry. In one embodiment of the invention, a light plane is used to monitor entry of objects through a doorway or window. In another embodiment of the invention, a box of light is generated to monitor travel of objects in a corridor or hallway, for example, monitoring the direction of travel and only allowing objects to travel in one direction through the corridor. In one embodiment of the invention, an alarm is activated in response to detecting travel in the incorrect direction.

In the case of a window to a house, for example, embodiments of the present invention generate a signal to sound an alarm when an intruder breaks a plane or sheet of light monitoring a point of entry (e.g., a door, window, ventilation duct, etc.). In another embodiment of the invention, objects are allowed to pass through a point of entry in a particular direction without triggering the alarm.

In the case of an elevator or garage door, embodiments of the present invention can be coupled to the opening-closing mechanism such that when a person or object breaks a light array monitoring the opening, the closing-opening mechanism is disabled, thus rendering the mechanism useless to the intruder or from harming someone in the way of a moving object. While many elevators and garage door opening systems use some sort of optical technology, they typically only check clearance at one height. The systems are easily overcome by stepping over the single beam, for example.

In one embodiment of the invention, comparing the time of light interruption for photodetectors arranged in an array along the direction of restricted movement can allow the direction of travel (e.g., right direction vs. wrong direction) to be determined electronically. If a person is detected traveling in the wrong direction, an alarm can be sounded.

In another embodiment of the invention, a linear array of sensors can be arranged along a hallway. The sensors should be arranged such that they are close enough to the ground to prevent someone crawling underneath and close enough together to prevent someone from stepping in between them, such an array can be used to detect travel in the wrong direction.

Some benefits of embodiments of the present invention include reduced numbers of security guards at entry points or travel corridors and guarding points of entry that were considered unarmable with conventional entry detection systems which provides added safety to occupants of buildings and homes. In addition, embodiments of the present invention provide security to windows and doors even in their open state allowing one to keep windows open for ventilation while maintaining a level of protection. Furthermore, safety can be greatly improved by incorporating embodiments of the present invention into opening and closing mechanisms such as automatic doors to prevent unintentional closing or opening of a door on a person or object.

Other benefits of the present invention include simplicity in electrical requirements since embodiments of the present invention only require electricity on one side of an area being protected. In one embodiment of the invention, a retroreflector is used to reflect light back to a sensor which does not require electricity to operate.

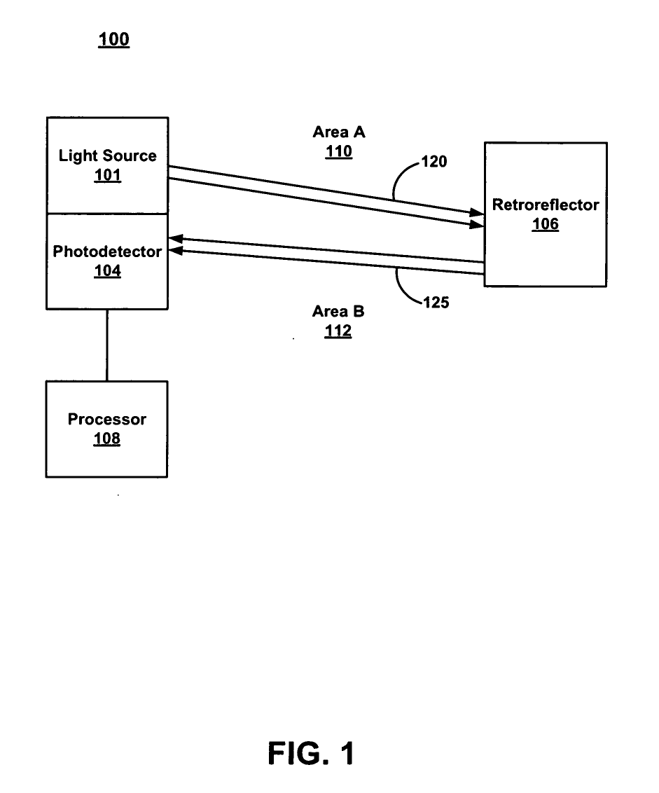

FIG. 1 is a block diagram of an exemplary system 100 for detecting entry of an object from a first area (A) 110 to a second area (B) 112 (or vice versa) in accordance with embodiments of the present invention. System 100 includes a light source 101 for generating a light beam 120. In one embodiment of the invention, the light source is a light emitting diode (LED) or semiconductor laser however, it is appreciated that light source 101 can be any light source (generating a wavelength visible or not visible to the human eye) in accordance with embodiments of the present invention. In one embodiment of the invention, the light source generates an infrared light beam.

System 100 further includes a retroreflector 106. A retroreflector is a type of surface with unusual reflectance characteristics, namely that it reflects light mainly back in the direction from which it came. This makes retroreflecting surfaces appear much brighter than matte surfaces, if the light source is located very near to the viewer, and dark otherwise. Retroreflecting surfaces are often found on road markings and signs.

The system further includes a photodetector 104 located adjacent to the light source 101. In one embodiment of the invention, a light blocking baffle (not shown) is located between the light source 01 and the photodetector 104 to prevent the photodetector 104 from detecting the light beam 120 prior to being reflected by the retroreflector 106. The light blocking baffle prevents scattered light from being detected by the photodetector 104. It is appreciated that any number of devices could be used in accordance with embodiments of the present invention to block unwanted light from the photodetector 104.

For example, in another embodiment of the invention, the photodetector 104 includes a bandpass light filter (not shown) for filtering wavelengths of light other than the wavelength band generated by the light source 101. The light filter makes the system 100 more robust against ambient light sources (e.g., natural light and other light sources around system 100). In one embodiment of the invention, the light filter is an optical film placed over the optical eye of the photodetector, however, it is appreciated that any number of light filters could be used in accordance with embodiments of the present invention. In one embodiment of the invention, the light source 101, light blocking baffle and photodetector 104 are coupled together forming an optoelectronic unit.

In one embodiment of the invention, the light source 101 is aimed across a gap to be protected (e.g., a door, window, etc.). The light beam provides a security threshold separating the first area (A) 110 from the second area (B) 112. The photodetector 104 detects the reflected light beam 125 and generates a signal in response to detecting a disruption in the light beam. In one embodiment of the invention, a processor 108 is coupled to the photodetector. In one embodiment of the invention, the photodetector signals a disruption when either the light beam 120 or the reflected light beam 125 is broken.

In one embodiment of the invention, the processor 108 is coupled to the light source in addition to the photodetector 104. In this embodiment of the invention, characteristics of the light source are modulated (e.g., amplitude or frequency of the generated light beam) to further decrease problems associated with ambient light and/or attempts to overcome the system by intruders.

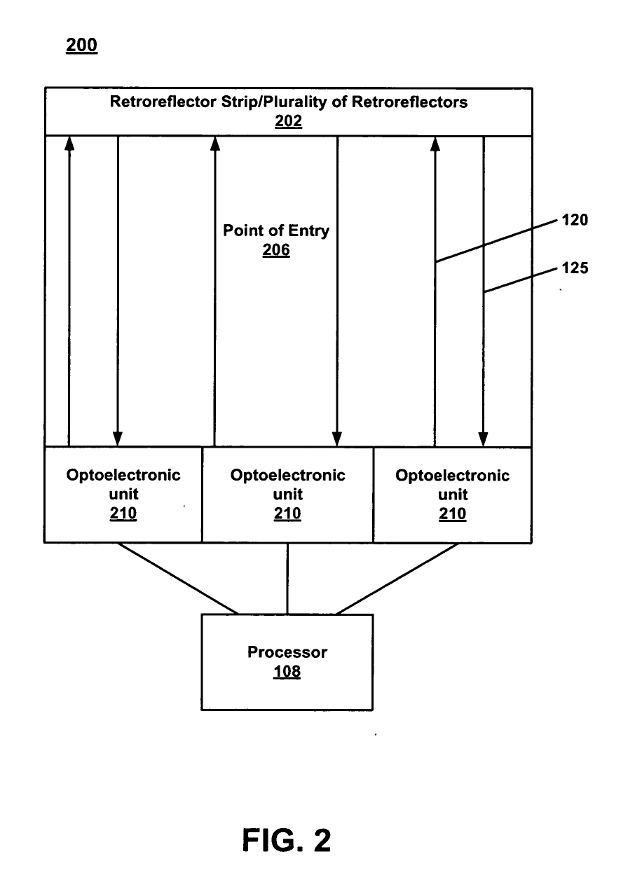

FIG. 2 is an illustration 200 of an entry detection system implemented to protect a point of entry using a plane of light in accordance with embodiments of the present invention. In this embodiment of the invention, the point of entry 206 is a two-dimensional opening, for example a window or door opening. In this embodiment of the invention, a plurality of optoelectronic units 210 is positioned on a first end of the opening. As stated above, an optoelectronic unit comprises a light source, a photodetector and an optional light blocking baffle and/or bandpass light filter. In one embodiment of the invention, each of the plurality of optoelectronic units 210 is electronically coupled to a processor 108.

In one embodiment of the invention, the optoelectronic units 210 generate a light beam 120 which is aimed at a retroreflector 202 located on the opposite end of the optoelectronic units 210. In one embodiment of the invention, the retroreflector 202 is a strip of retroreflective material. In another embodiment of the invention, the retroreflector 202 comprises a plurality of individual retroreflectors, such as a linear array of retroreflectors. In this embodiment of the invention, the generated light is reflected 125 back to the optoelectronic units 210 creating a plane of light. The plane of light (or light pane) is effectively a boundary separating a first area from a second area. For example, in the case of a window opening, the light plane separates the inside of the structure (e.g., behind the window) from the outside of the structure (e.g., in front of the window).

In one embodiment of the invention, a three-dimensional array (comprising a plurality of light beams) of light is generated. In this embodiment of the invention, a direction of entry can be determined by processor 108 based on which of the light beams is broken. For example, if a light beam on the outside plane of the three-dimensional light array is broken, it can be determined that the entry is from the outside.

If a light beam on the inside plane of the three-dimensional light array is broken, the entry is determined to be from the inside. In this embodiment of the invention, one can protect a point of entry such as a window and have the freedom to put a head out for fresh air without setting off an alarm. When an object enters from the outside, the alarm would be activated. In one embodiment of the invention, the processor 108 can determine statistics such as velocity, direction of entry, etc. of an object interrupting the light plane.

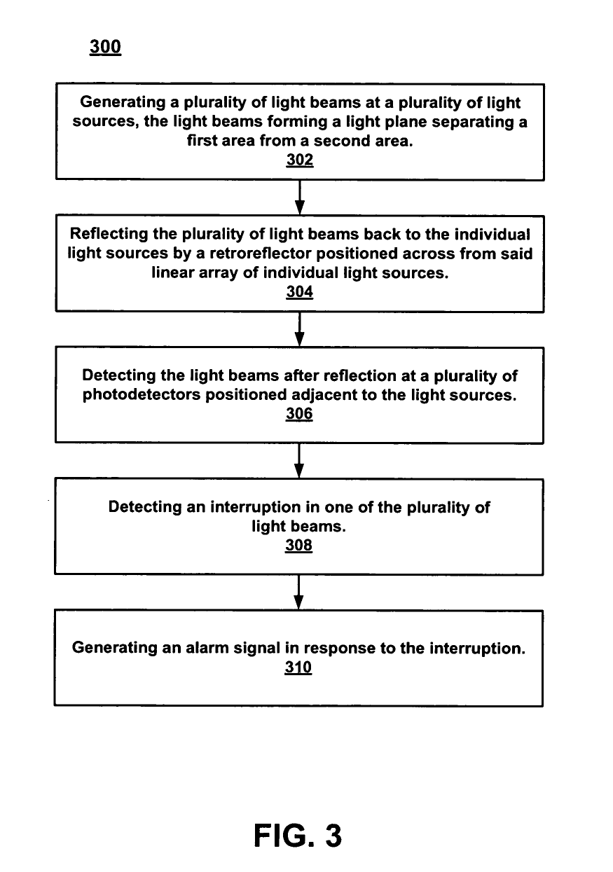

FIG. 3 is a flow diagram of an exemplary method 300 of detecting entry from a first area to a second area in accordance with embodiments of the present invention.

At step 302, method 300 includes generating a plurality of light beams at a plurality of light sources, the light beams forming a light plane separating a first area from a second area. In one embodiment of the invention, the light beams include an infrared wavelength. In one embodiment of the invention, the light sources include an LED.

At step 304, method 300 includes reflecting the plurality of light beams back to the individual light sources by a retroreflector positioned across from said linear array of individual light sources. In one embodiment of the invention, the retroreflector includes a plurality of individual retroreflectors. In another embodiment of the invention, the retroreflector is a strip (or any other shape) of retroreflective material.

At step 306, method 300 includes detecting the light beams after reflection at a plurality of photodetectors positioned adjacent to the light sources. In one embodiment of the invention, the photodetectors and light source are part of an optoelectronic unit. In one embodiment of the invention, a light-blocking baffle is positioned to block the light beam from the photodetector prior to being reflected by the retroreflector. In one embodiment of the invention, the photodetector comprises a bandpass filter for blocking transmission of light wavelengths except for the wavelength band generated by the light source.

In one embodiment of the invention, a characteristic of the light beam is modulated to prevent ambient light from interfering with the functionality of the photodetector. In one embodiment of the invention, modulation of the light beam characteristics makes it difficult for a would-be intruder to compromise the system and enter undetected.

At step 308, method 300 includes detecting an interruption in one of the plurality of light beams. In one embodiment of the invention, a direction and/or location of entry can be determined based on which of the plurality of light beams is disrupted and/or the order in which the different light beams are interrupted. At step 310, method 300 includes generating an alarm signal in response to the interruption.

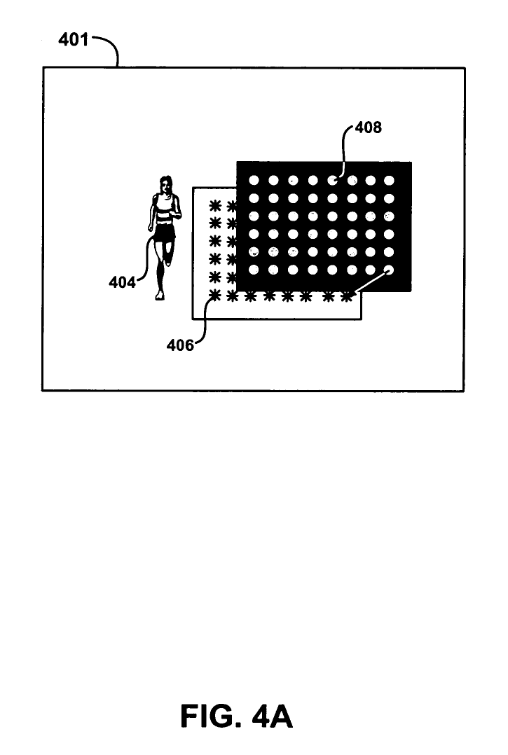

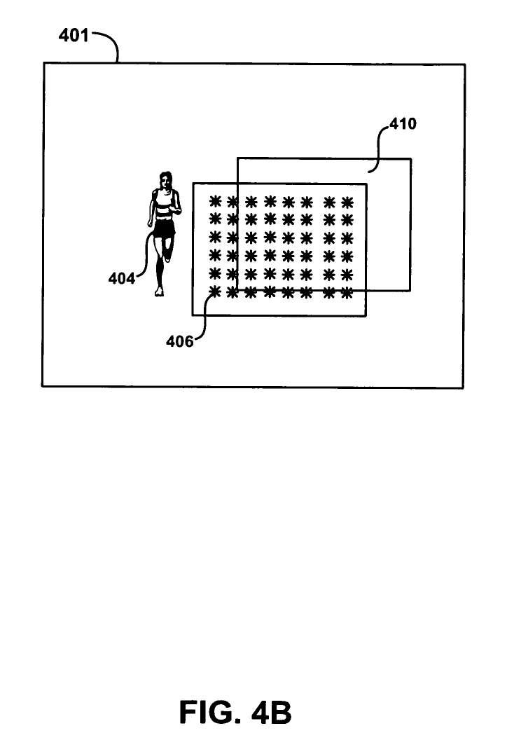

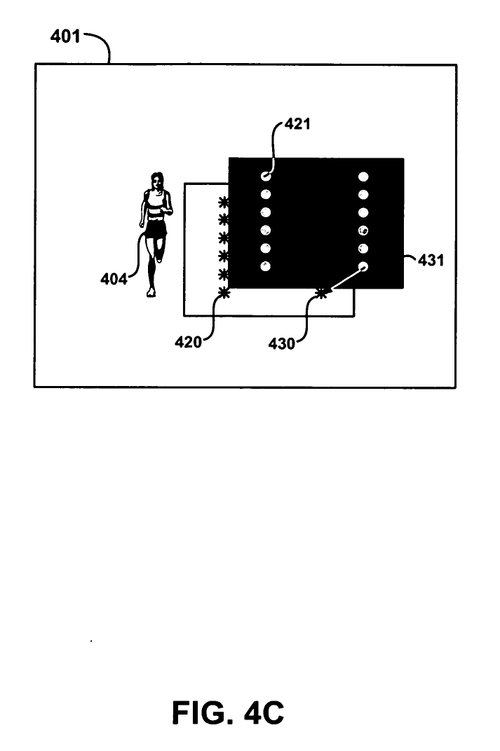

FIG. 4A is an illustration of a corridor 401 illuminated by a two-dimensional array of optoelectronic units 406 for detecting a direction of entry in accordance with embodiments of the present invention. Directly across from each optoelectronic unit 406 is a retroreflector. A person 404 walking or running down the corridor will create a body shaped shadow on the photodetectors of the optoelectronic units 406 directed at the person 404. Standard optical flow image processing techniques or even simpler methods can be used to determine which direction a person 404 is moving from the temporal and spatial characteristics of the interruptions. If the optical flow processing indicates movement in the wrong direction, an alarm will sound.

FIG. 4B is an illustration of a corridor 401 illuminated by a two-dimensional array of optoelectronic units 406 across from a wall of retroreflective material 410 for detecting a direction of entry in accordance with embodiments of the present invention. A person 404 walking or running down the corridor will create a body shaped shadow on the photodetectors of the optoelectronic units 406 directed at the person 404. Standard information processing techniques can be used to determine which way a person 404 is moving. If the optical flow processing indicates movement in the wrong direction, an alarm will sound.

FIG. 4C is an illustration of a corridor 401 illuminated by two linear arrays (array 420 and array 430) of optoelectronic units creating two sheets of light for detecting a direction of entry in accordance with embodiments of the present invention. Directly across from each linear array of optoelectronic units (420 and 430) is a linear array of retroreflectors (421 and 431). In one embodiment of the invention, retroreflector arrays 421 and 431 comprise strips of retroreflective material. For access control in one direction, embodiments of the present invention check if the shadow appears on the left side, then on the right side, for example.

It is appreciated that the linear array (e.g., array 420 and/or array 430) of optoelectronic units could be arranged to run parallel to the length of the corridor 401, located close to the floor of the corridor 401. If they are low enough to the floor to prevent someone crawling underneath and close enough together to prevent someone from stepping in between them, such an array can also be used to detect travel in the wrong direction.]

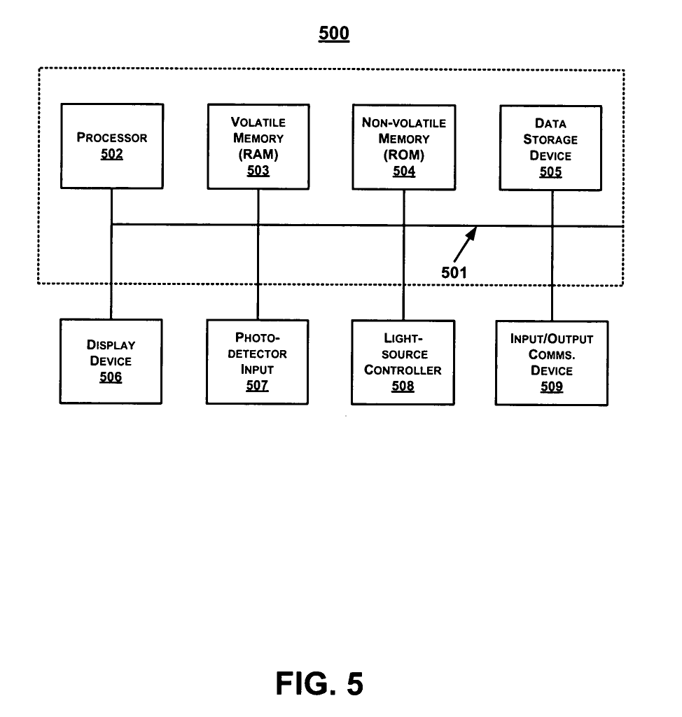

Referring now to FIG. 5, a block diagram of exemplary computer system 500 is shown. It is appreciated that computer system 500 of FIG. 5 described herein illustrates an exemplary configuration of an operational platform upon which embodiments of the present invention can be implemented. Nevertheless, other computer systems with differing configurations can also be used in place of computer system 500 within the scope of the present invention. For example, computer system 500 could be a server system, a node on a network, a personal computer or an embedded computer system such as a mobile telephone or pager system. Furthermore, computer system 500 could be a multiprocessor computer system.

Computer system 500 includes an address/data bus 501 for communicating information, a central processor 502 coupled with bus 501 for processing information and instructions, a volatile memory unit 503 (e.g., random access memory, static RAM, dynamic RAM, etc.) coupled with bus 501 for storing information and instructions for central processor 502 and a non-volatile memory unit 504 (e.g., read only memory, programmable ROM, flash memory, EPROM, EEPROM, etc.) coupled with bus 501 for storing static information and instructions for processor 502. Computer system 500 may also contain an optional display device 506 coupled to bus 501 for displaying information to the computer user. Moreover, computer system 500 also includes a data storage device 505 (e.g., disk drive) for storing information and instructions.

Also included in computer system 500 of FIG. 5 is an optional photodetector input 507. Photodetector input 507 can communicate information and command selections to central processor 502. Computer system 500 also includes light source controller 508 coupled to bus 501. In one embodiment of the invention characteristics of a light source can be manipulated by a signal generated by light source controller 508. Computer system 500 also includes signal communication interface 509, which is also coupled to bus 501, and can be a serial port. Communication interface 509 can also include number of wireless communication mechanisms such as infrared or a Bluetooth protocol.

Embodiments of the present invention, a system and method for detecting entry of an object from a first area to a second area have been described. While the present invention has been described in particular embodiments, it should be appreciated that the present invention should not be construed as limited by such embodiments, but rather construed according to the following Claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A system for detecting entry of an object from a first area into a second area comprising:
a light source for generating a light beam, said light beam defining a boundary between said first area and said second area;
a retroreflector positioned across from said light source, said retroreflector for reflecting said light beam back towards said light source;
a photodetector positioned adjacent to said light source, said photodetector for detecting said light beam after reflection wherein said photodetector generates a signal in response to detecting an interruption in said light beam signaling entry of said object from said first area to said second area.

2. The system as described in claim 1 further comprising:
a light-blocking baffle positioned between said light source and said photodetector for blocking said light beam prior to being reflected by said retroreflector.

3. The system as described in claim 1 further comprising:
a light filter coupled to said photodetector for preventing transmission of wavelengths of light except a wavelength band associated with said light beam.

4. The system as described in claim 1 wherein said light source is a light emitting diode (LED) or a semiconductor laser.

5. The system as described in claim 1 wherein said light source is modulated and generates a modulated light beam.

6. The system as described in claim 1 wherein said light beam comprises a substantially infrared wavelength.

7. A system for detecting entry of an object from a first area to a second area comprising:
a linear array of individual light sources for generating a plurality of light beams, said light beams forming a light plane separating said first area from said second area;
a retroreflector positioned across from said linear array of individual light sources, said retroreflector for reflecting said plurality of light beams back to said individual light sources;
a plurality of photodetectors positioned adjacent to said light sources, said photodetectors for detecting said light beams after reflection; and
a processor coupled to said plurality of photodetector for generating a signal in response to one of said plurality of photodetector detecting an interruption in one of said plurality of light beams.

8. The system as described in claim 7 further comprising:
a plurality of light-blocking baffles positioned between each of said plurality of light sources and said plurality of photodetectors for blocking said plurality of light beams from said plurality of photodetectors prior to being reflected by said retroreflector.

9. The system as described in claim 7 further comprising:
a light filter coupled to each of said plurality of photodetectors for filtering wavelengths of light except a wavelength associated with said light beam.

10. The system as described in claim 7 wherein said plurality of light sources comprises a light emitting diode (LED).

11. The system as described in claim 7 wherein one of said plurality of light sources is modulated and generates a modulated light beam.

12. The system as described in claim 7 wherein said processor determines a direction of entry based on the order in which said plurality of light beams is interrupted.

13. The system as described in claim 7 wherein said processor determines a location of entry based on which of said plurality of light beams is interrupted.

14. The system as described in claim 7 wherein said retroreflector comprises a plurality of individual retroreflectors.

15. A method for detecting entry of an object from a first area to a second area comprising:
generating a plurality of light beams at a plurality of light sources, said light beams forming a light plane separating said first area from said second area;
reflecting said plurality of light beams back to said individual light sources by a retroreflector positioned across from said linear array of individual light sources;
detecting said light beams after reflection at a plurality of photodetectors positioned adjacent to said light sources;
detecting an interruption in one of said plurality of light beams; and
generating an alarm signal in response to said interruption.

16. The method as described in claim 15 further comprising:
blocking one of said plurality of light beams prior to being reflected with a light-blocking baffle positioned between one of said plurality of said light sources and one of said plurality of said photodetectors.

17. The method as described in claim 15 further comprising:
filtering wavelengths of light except a wavelength associated with said light beam with a light filter coupled to one of said plurality of photodetectors.

18. The method as described in claim 15 wherein one of said plurality of light sources is a light emitting diode (LED).

19. The method as described in claim 15 further comprising:
modulating one of said plurality of light sources to generate a modulated light beam.

20. The method as described in claim 15 wherein said plurality of light beams form a three dimensional light box separating said first area from said second area.
